(19) United States
(12) Patent Application Publication
(10) Pub. No.: US 2009/0024768 A1
(43) Pub. Date: Jan. 22, 2009

(54) CONNECTION MANAGEMENT PROGRAM, CONNECTION MANAGEMENT METHOD AND INFORMATION PROCESSING APPARATUS

(75) Inventors: Tetsutaro MARUYAMA, Kawasaki (JP); Masahisa Tamura, Kawasaki (JP); Kazutaka Ogihara, Kawasaki (JP); Takashi Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/173,486

(22) Filed: Jul. 15, 2008

(30) Foreign Application Priority Data
Jul. 20, 2007 (JP) 2007-188918

(51) Int. Cl. G06F 3/00

(52) U.S. Cl. 710/15

(57) ABSTRACT

A storage apparatus connection managing apparatus, detecting upon detecting that a new storage apparatus has been connected to the computer, whether the storage apparatus includes a data area capable of storing data and a program area having preliminarily stored therein a data access program for accessing the data area of the storage apparatus and a volume management program for managing a data storage destination in an integrated manner when storing data in a distributed manner in a plurality of storage apparatuses. The apparatus reads the data access program and the volume management program from the program area of the detected storage apparatus and activates the programs in the apparatus.

### CROSS-REFERENCE TO RELATED APPLICATIONS

This application is related to and claims the benefit of priority from Japanese Patent Application No. 2007-188918, filed on Jul. 20, 2007, the entire contents of which are incorporated herein by reference.

### BACKGROUND

### FIELD

The present invention relates to a storage medium having recorded thereon a connection management program for making a connected apparatus accessible and to a connection management method and an information processing apparatus, and more particularly to a storage medium having recorded thereon a connection management program for making multiple connected storage apparatuses accessible and to a connection management method and an information processing apparatus.

### SUMMARY

A connection management apparatus, method and program include detecting, upon detecting that a new storage apparatus has been connected to the computer, whether or not the storage apparatus includes a data area capable of storing data and a program area having preliminarily stored therein a data access program for accessing the data area of the storage apparatus and a volume management program for managing data storage destination in an integrated manner when storing data in a distributed manner in a plurality of storage apparatuses, and reading the data access program and the volume management program from the program area of the storage apparatus detected by the connection detection unit and activating the programs in the computer.

Additional aspects and/or advantages will be set forth in part in the description which follows and, in part, will be apparent from the description, or may be learned by practice of the invention. Reference being had to the accompanying drawings forming a part hereof, wherein like numerals refer to like parts throughout.

### BRIEF DESCRIPTION OF THE DRAWINGS

FIG. 1 is a view illustrating the outline of the present embodiment;

FIG. 2 is a view illustrating a system configuration according to the present embodiment;

FIG. 3 is a view illustrating a hardware configuration of a user terminal apparatus;

FIG. 4 is a schematic view illustrating a data structure of logical volume;

FIG. 5 is a view illustrating a module structure of an external storage apparatus;

FIG. 6 is a view illustrating a module structure of a user terminal apparatus;

FIG. 7 is a view illustrating an exemplary data structure of logical volume table;

FIG. 8 is a view illustrating an exemplary data structure of slice information table;

FIG. 9 is a flowchart illustrating a procedure of area adding processing;

FIG. 10 is a flowchart illustrating a procedure of area deleting processing; and

FIG. 11 is a sequence chart illustrating an exemplary flow from connection to disconnection.

### DETAILED DESCRIPTION OF THE PREFERRED EMBODIMENTS

There are increasing demands for higher performance of storage systems used to store data. For example, there is an increasing demand for high-speed response to data read commands or write commands; that is, high response performance. Also, there is an increasing demand that the accumulated data should not disappear even when a failure occurs in a part of hardware constituting the storage system; that is, high reliability. Further, there is an increasing demand that storage capacity can be increased as needed according to the increase in stored data; that is, high extensibility.

As a storage system which meets such various demands for high performance, there is known a distributed storage system. In the distributed storage system, multiple storage nodes including storage apparatuses are connected via a network, so that data is stored in a distributed manner. Here, in the typical distributed storage system, data redundancy is implemented; that is, the same data is stored redundantly in multiple storage nodes (e.g., International Patent Publication Number WO2003/027866). Also, a management computer manages all the storage areas of the multiple storage nodes, so that a single virtual storage area is configured (e.g., International Patent Publication Number WO2003/050707). As a result, there can be implemented a storage system with satisfactory response performance, reliability and extensibility.

However, in the related art distributed storage systems as described in Patent Documents 1 and 2, there is assumed a large scale system environment in which the amount of processed data and the number of users are extremely large, thus resulting in a complex system. Accordingly, it takes deep specialized knowledge and much labor to construct and operate the distributed storage system, and thus the system cannot be easily used.

Meanwhile, there are demands that a storage system with response performance, reliability and extensibility as high as the distributed storage system can be used even in a small-scale organization or at home. Particularly, in recent years, the volume of data processed in a small-scale organization or at home has become large with the advancement of software technology, so such demands are increasing.

An embodiment of the present invention will be described in detail below with reference to the drawings. Firstly the outline of the present invention will be described and thereafter the specific content of the embodiment will be described.

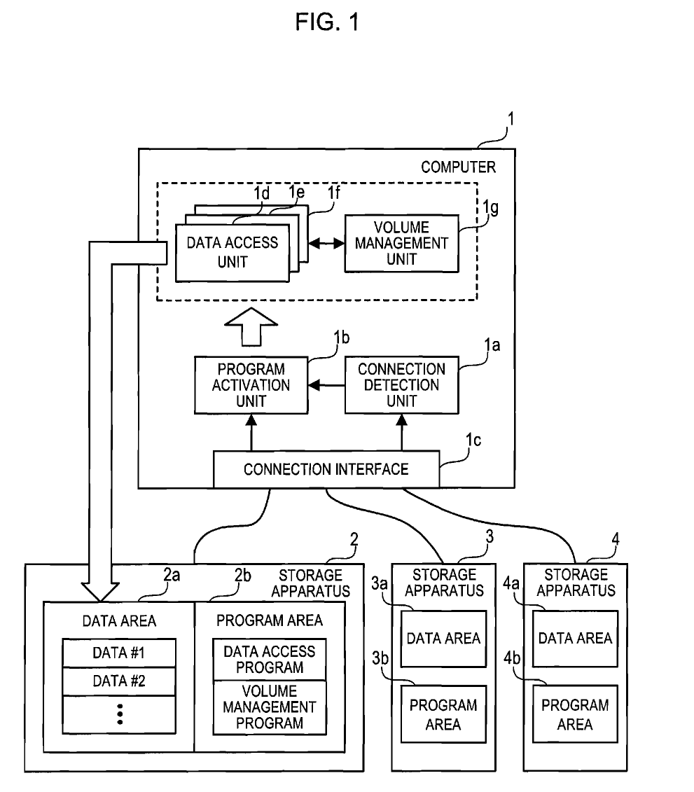

FIG. 1 is a view illustrating the outline of the present embodiment. A computer 1 detects connections with storage apparatuses 2, 3 and 4 and allows application programs or the like that are executing in the computer 1 to use data areas 2a, 3a and 4a. The computer 1 includes a connection detection unit 1a, program activation unit 1b and connection interface 1c. The connection detection unit 1a and program activation unit 1b are implemented, for example, by causing the computer 1 to execute a prescribed connection management program.

When the storage apparatuses 2, 3 and 4 are connected to the connection interface 1c, the connection detection unit 1a detects this; and multiple storage apparatuses can be connected to the connection interface 1c in parallel. Here, the connection detection unit 1a detects whether the storage apparatuses 2, 3 and 4 include the data areas 2a, 3a and 4a and program areas 2b, 3b and 4b.

The data areas 2a, 3a and 4a, which are storage areas where data can be stored, can be used by the application programs or the like executed in the computer 1. In the idle state, the data areas 2a, 3a and 4a are empty. The storage capacities of the data areas 2a, 3a and 4a don't need to be identical.

The program areas 2b, 3b and 4b, which are storage areas where a data access program and volume management program are preliminarily stored, cannot be used by the application program and the like. Here, the data access program is a program for accessing the data area of the storage apparatus. The volume management program is a program for managing the data storage destination in an integrated manner when storing data into multiple storage apparatuses 2, 3 and 4 in a distributed manner.

When the connection detection unit la detects the data areas 2a, 3a and 4a and the program areas 2b, 3b and 4b, the program activation unit 1b reads the data access programs and volume management programs from the program areas 2b, 3b and 4b. Then, the program activation unit 1b activates the read data access programs in the computer 1 and thereby implements data access units 1d, 1e and 1f. Also, the program activation unit 1b activates the read volume management programs in the computer 1 and thereby implements a volume management unit 1g.

Here, each of the data access units 1d, 1e and 1f works for one of the storage apparatuses. More specifically, the data access unit 1d reads or writes data from/to the data area 2a of the storage area 2. The data access unit 1e reads or writes data from/to the data area 3a of the storage area 3. The data access unit 1f reads or writes data from/to the data area 4a of the storage area 4.

Only one volume management unit 1g is prepared for the multiple storage apparatuses 2, 3 and 4. That is, when a storage apparatus is initially connected to the connection interface 1c, a volume management program read from that storage apparatus is activated, whereby the volume management unit 1g is implemented; and when the second and subsequent storage apparatuses are connected to the connection interface 1c, no volume management program is additionally activated.

Thereafter, the application program and the like executed in the computer 1 access the volume information managed by the volume management unit 1g and thereby identify a storage apparatus having stored therein desired data, or a storage apparatus into which new data is to be stored. Then, the data area of the identified storage apparatus is accessed via the data access unit corresponding to that storage apparatus, whereby data is read or written.

In the above description, one data access unit works for one storage apparatus, but one data access unit may work for multiple storage apparatuses. Further, in the above description, only one volume management unit is prepared, but multiple volume management units may be prepared so that volume information is managed in a distributed manner.

With such computer 1, when the storage apparatuses 2, 3 and 4 are initially connected to the computer 1, the connection detection unit 1a detects whether the storage apparatuses 2, 3 and 4 include the data areas 2a, 3a and 4a and the program areas 2b, 3b and 4b having stored therein the data access program and volume management program. Then, the program activation unit 1b reads the data access program and volume management program and activates the programs in the computer 1.

Accordingly, hereafter, the application program and the like executed by the computer 1 can access, via the data access units 1d, 1e and 1f and the volume management unit 1g, data which is managed in a distributed manner in the data areas 2a, 3a and 4a. Consequently, there is no need to perform preliminary special setting in the computer 1; solely by connecting the storage apparatuses 2, 3 and 4 to the computer 1, the distributed data management can be implemented.

The present embodiment will be described in detail below with reference to the drawings.

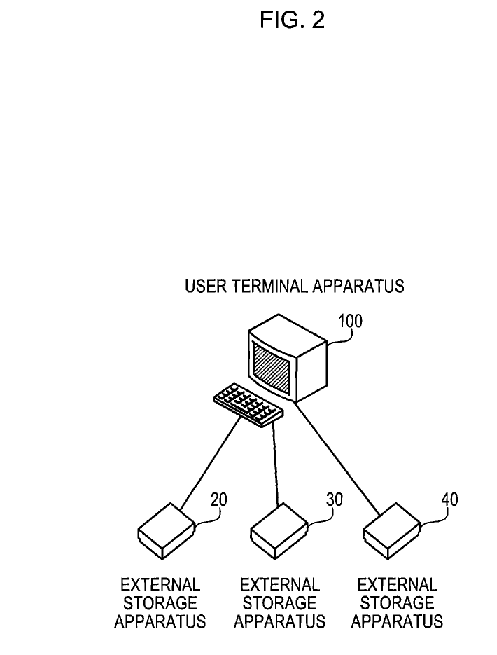

FIG. 2 is a view illustrating a system configuration according to the present embodiment. The present embodiment is constituted of one user terminal apparatus 100 and multiple external storage apparatuses 20, 30 and 40. The user terminal apparatus 100 is a computer operable by a user, e.g., a desktop personal computer. Multiple external storage apparatuses 20, 30 and 40 can be connected to the user terminal apparatus 100 in parallel.

The external storage apparatuses 20, 30 and 40 are external storage apparatuses connectable to the user terminal apparatus 100. According to the present embodiment, it is assumed that the external storage apparatuses 20, 30 and 40 are hard disk apparatuses. Here, the storage capacities of the external storage apparatuses 20, 30 and 40 don't need to be identical. Further, the external storage apparatuses 20, 30 and 40 can be attached or detached to the user terminal apparatus 1 00 at all times independently of whether the user terminal apparatus 100 is active or not.

A hardware configuration of the user terminal apparatus 100 will be described.

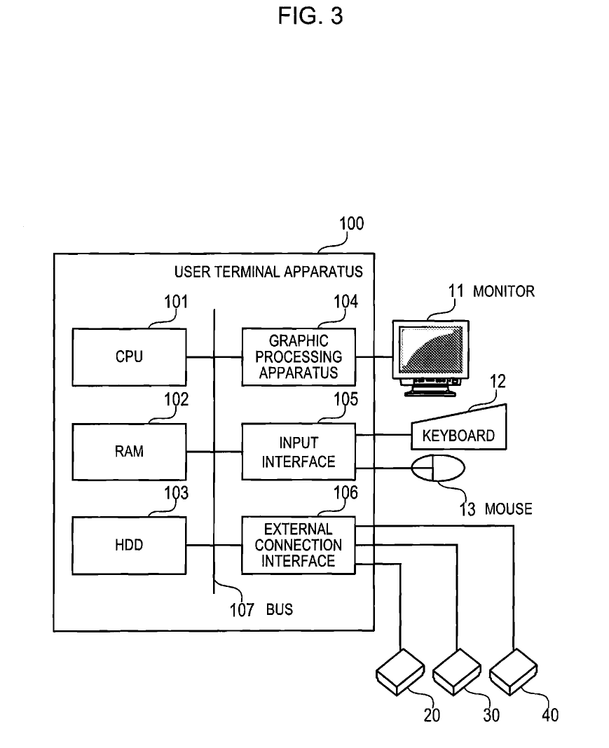

FIG. 3 is a view illustrating a hardware configuration of the user terminal apparatus. A CPU (Central Processing Unit) 101 controls the entire terminal apparatus 100. Connected via a bus 107 to the CPU 101 are a RAM (Random Access Memory) 102, hard disk drive (HDD: Hard Disk Drive) 103, graphic processing apparatus 104, input interface 105 and external connection interface 106.

In the RAM 102, there are temporarily stored at least a part of OS (Operating System) and application programs to be executed by the CPU 101. Also, in the RAM 102, there are temporarily stored at least a part of various types of data needed for processings by the CPU 101. In the HDD 103, there are stored OS program and application programs. Also, there are stored various types of data needed for processings by the CPU 101.

Connected to the graphic processing apparatus 104 is a monitor 11. Based on a command from the CPU 101, the graphic processing apparatus 104 causes images to be displayed on the screen of the monitor 11. Connected to the input interface 105 are a keyboard 12 and mouse 13. The input interface 105 transmits via the bus 107, signals sent from the keyboard 12 and mouse 13 to the CPU 101. Multiple external storage apparatuses 20, 30 and 40 can be connected to the external connection interface 106 in parallel. The external connection interface 106 receives or sends data from/to the connected external storage apparatuses.

With the above-described hardware configuration, the processing function of the present embodiment can be implemented.

Here, logical volume managed by the user terminal apparatus 100 will be described. The logical volume is a virtual volume which allows data stored in a distributed manner in the external storage apparatuses 20, 30 and 40 to be used easily by the application programs executed in the user terminal apparatus 100. More specifically, the logical volume allows the data areas for storing data in the external storage apparatuses 20, 30 and 40 to be identified as a single virtual area.

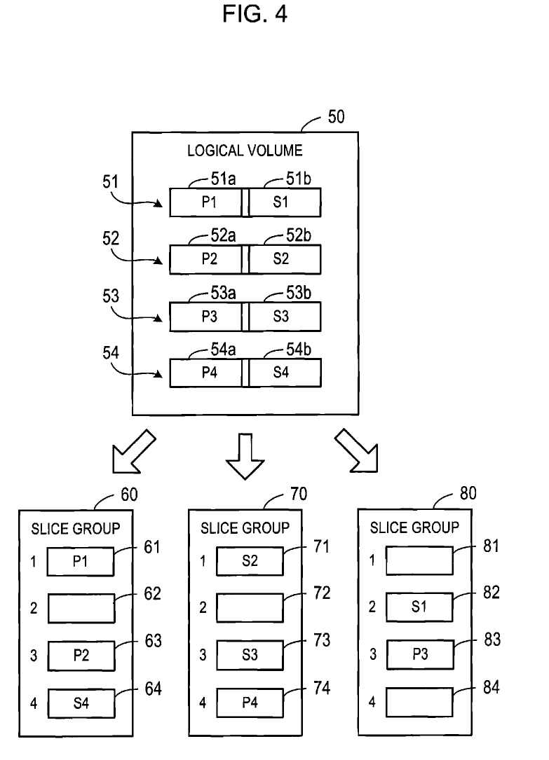

FIG. 4 is a schematic view illustrating a data structure of the logical volume. In the logical volume, the data areas of the external storage apparatuses 20, 30 and 40 are each divided into multiple slices for management. More specifically, a slice group 60 constituted of slices 61, 62, 63 and 64 is configured with respect to the data area of the external storage apparatus 20; a slice group 70 constituted of slices 71, 72, 73 and 74 is configured with respect to the data area of the external storage apparatus 30; a slice group 80 constituted of slices 81, 82, 83 and 84 is configured with respect to the data area of the external storage apparatus 40.

The logical volume 50 is constituted of segments 51, 52, 53 and 54. The segments 51, 52, 53 and 54 are each constituted of a pair of primary slice (51a, 52a, 53a, 54a) and secondary slice (51b, 52b, 53b, 54b). Arrangement is made so that a primary slice and secondary slice of the same segment belong to different external storage apparatuses.

Referring to the example of FIG. 4, slice ID is indicated by a combination of alphabet “P” or “S” and numeric character. “P” indicates primary slice; and “S” indicates secondary slice. Numeric character following alphabet indicates the segment number. For example, “P1” indicates the primary slice 51a of the first segment 51; and “S1” indicates the secondary slice 51b.

Each of the primary slices and secondary slices of the logical volume 50 having this structure is associated with one of the slices of the external storage apparatuses 20, 30 and 40. For example, the primary slice 51a of the segment 51 is associated with slice 61 of the external storage apparatus 20; the secondary slice 51b is associated with slice 82 of the external storage apparatus 40.

In the data areas of the external storage apparatuses 20, 30 and 40, there are stored primary slice or secondary slice data associated with the primary slice. The data of primary slice and secondary slice belonging to the same segment has the same content. That is, each data of primary slice and secondary slice is redundantly stored in the external storage apparatuses 20, 30 and 40. Here, the primary slice acts as the ordinary access destination of data; and the secondary slice acts as a backup of data.

The module structure of the external storage apparatuses 20, 30 and 40 and the user terminal apparatus 100 will be described.

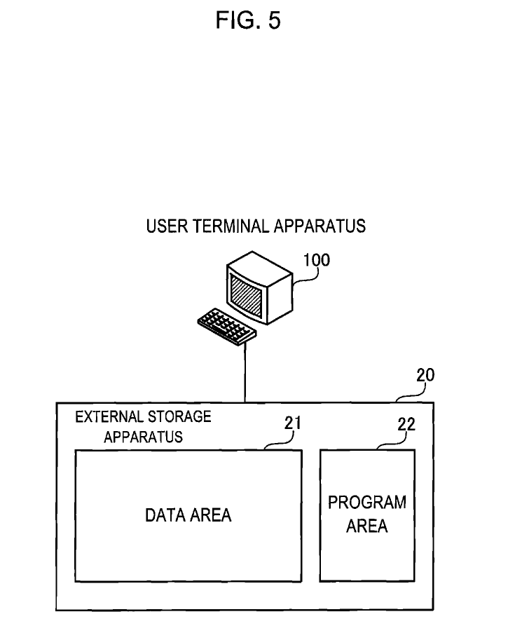

FIG. 5 is a view illustrating a module structure of the external storage apparatus. The external storage apparatus 20 includes a data area 21 and program area 22. The data area 21 and program area 22 are produced by preliminarily partitioning one disk area included in the external storage apparatus 20 into two areas.

The data area 21, which is a disk area where data can be stored, can be used by the application programs executed in the user terminal apparatus 100. In the idle state, the data area 21 is empty. When the external storage apparatus 20 is connected to the user terminal apparatus 100, the data area 21 is divided into multiple slices for management.

The program area 22, which is a disk area where the program for managing an external storage apparatus connected to the user terminal apparatus 100 is preliminarily stored, cannot be used by the application programs executed in the user terminal apparatus 100. That is, the application programs cannot recognize the program area 22.

More specifically, stored in the program area 22 are a control program, access management program and disk management program. The control program is a program for managing the data storage destination in an integrated manner when storing data in a distributed manner into the external storage apparatuses connected to the user terminal apparatus 100. The control program manages the logical volume illustrated in FIG. 4.

The access management program is a program for managing in an integrated manner, a request for access to data made by the user terminal apparatus 100. When a request for access to data is made, the access management program consults the logical volume managed by the control program to identify an external storage apparatus being the access destination and thereby causes the disk management program to access the specified external storage apparatus.

The disk management program is a program for reading or writing data from/to the data area of the external storage apparatus. In response to a request from the access management program, the disk management program accesses the data area of the external storage apparatus for which the own program works for (for example, the disk management program accesses a corresponding/associated therewith external storage apparatus) and sends back the access result to the access management program.

The external storage apparatuses 30 and 40 are also implemented by a module structure similar to that of the external storage apparatus 20. Here, programs stored in the program areas of the external storage apparatuses 30 and 40 are identical to those stored in the program area 22 of the external storage apparatus 20.

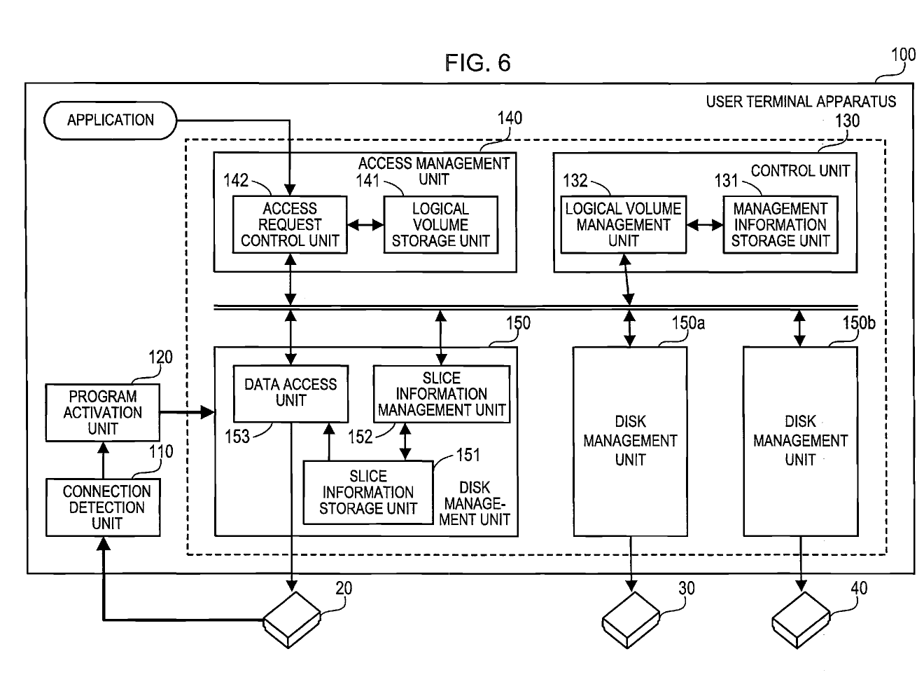

FIG. 6 is a view illustrating a module structure of the user terminal apparatus 100. The user terminal apparatus 100 preliminarily includes a connection detection unit 110 and program activation unit 120. When the external storage apparatuses 20, 30 and 40 are connected to the user terminal apparatus 100, the programs are activated, whereby a control unit 130, access management unit 140 and disk management units 150, 150a and 150b are implemented.

More specifically, when the control program stored in the program area of an initially connected external storage apparatus is activated, the control unit 130 is implemented; when the access management program stored in the program area of the initially connected external storage apparatus is activated, the access management unit 140 is implemented.

When the disk management program stored in the program area 22 of the external storage apparatus 20 is activated, the disk management unit 150 is implemented; when the disk management program stored in the program area of the external storage apparatus 30 is activated, the disk management unit 150a is implemented; when the disk management program stored in the program area of the external storage apparatus 40 is activated, the disk management unit 150b is implemented.

In this way, the control unit 130 and access management unit 140 are activated one by one in the user terminal apparatus 100. In contrast, the disk management units 150, 150a and 150b are activated for each connected external storage apparatus (20, 30, 40).

When an external storage apparatus is connected to the external connection interface 106, the connection detection unit 110 detects this and notifies the program activation unit 120 about the newly connected external storage apparatus. Here, when OS is activated while multiple external storage apparatuses have been connected to the user terminal apparatus 100, the notification of the external storage apparatuses to the program activation unit 120 is performed in order of recognition by OS. Typically, OS recognizes external storage apparatuses in a random order.

The program activation unit 120 can access the program area of the external storage apparatus connected to the user terminal apparatus 100. The program activation unit 120 reads, upon reception of notification from the connection detection unit 110, programs from the program area of the external storage apparatus about which the notification has been performed, and activates the programs in the user terminal apparatus 100. In this case, when the control unit 130 and access management unit 140 have already been executed, the control program and access management program are not activated.

The control unit 130 includes a management information storage unit 131 and logical volume management unit 132. Stored in the management information storage unit 131 is slice information that is information on the slices included in the external storage apparatuses 20, 30 and 40. The logical volume management unit 132 collects the slice information on the external storage apparatuses 20, 30 and 40 from the disk management units 150,150a and 150b and stores it in the management information storage unit 131.

The logical volume management unit 132 produces a logical volume based on the slice information stored in the management information storage unit 131. In the logical volume, segments are managed using logical address being virtual address so that the data areas of the external storage apparatuses 20, 30 and 40 are managed in an integrated manner. The logical volume includes logical address for identifying a segment and information for identifying primary slice and secondary slice belonging to the segment.

The logical volume management unit 132 can also produce multiple logical volumes. In this case, the application program recognizes that there are multiple independent virtual disk areas.

The logical volume management unit 132 periodically acquires notification indicating the operating state of the external storage apparatuses 20, 30 and 40; thus the logical volume management unit 132 knows whether or not the external storage apparatuses 20, 30 and 40 are in an ordinary operating state. The logical volume management unit 132 rearranges the primary slice and secondary slice when needed, to update the logical volume. In this case, the logical volume management unit 132 notifies the disk management unit corresponding to the external storage apparatus affected by the updating about the updated content.

Also, the logical volume management unit 132 notifies, upon reception of a logical volume access request from the access management unit 140, the access management unit 140 about the latest logical volume.

The access management unit 140 includes a logical volume storage unit 141 and access request control unit 142. Stored in the logical volume storage unit 141 is the logical volume managed by the logical volume management unit 132 of the control unit 130.

When the application program currently executed makes a data access request, the access request control unit 142 firstly checks whether or not a logical volume has been stored in the logical volume storage unit 141. If not, the access request control unit 142 acquires a logical volume from the logical volume management unit 132 of the control unit 130, and stores it in the logical volume storage unit 141.

Then, the access request control unit 142 identifies based on the logical volume, an external storage apparatus being the access destination. More specifically, the access request control unit 142 identifies a segment to which the data related to the access request belongs, and identifies an external storage apparatus to which the primary slice of the specified segment has been assigned. Then, the access request control unit 142 issues a command to a disk management unit corresponding to the specified external storage apparatus. Upon reception of the access result from the disk management unit, the access request control unit 142 sends back the access result to the application program which has made the request.

The disk management unit 150 includes a slice information storage unit 151, slice information management unit 152 and data access unit 153. Though omitted in FIG. 6, the disk management units 150a and 150b are also implemented by a module structure similar to that of the disk management unit 150.

Stored in the slice information storage unit 151 is slice information on the external storage apparatus 20. The slice information includes information such as an address for identifying a slice and the type of assigned slice (primary slice or secondary slice). Also, there is included information on the other slice of the pair of slices, i.e., information on the secondary slice with respect to the primary slice or information on the primary slice with respect to the secondary slice.

The slice information management unit 152 periodically notifies the logical volume management unit 132 of the control unit 130 about the operating state of the external storage apparatus 20. Further, the slice information management unit 152 sends back, upon reception of a slice information acquisition request from the logical volume management unit 132, the slice information stored in the slice information storage unit 151. Also, the slice information management unit 152 reflects, upon reception of a slice information updating command from the logical volume management unit 132, such updating content on the slice information stored in the slice information storage unit 151.

The data access unit 153 accesses, upon reception of a data access command from the access request control unit 142, the slice information stored in the slice information storage unit 151 and manipulates data stored in the data area of the external storage apparatus 20.

More specifically, the data access unit 153 determines, upon reception of a data read command (Read command) from the access request control unit 142, whether or not the slice to which the data belongs is a primary slice. If so, the data access unit 153 acquires the specified data from the external storage apparatus 20 and sends it to the access request control unit 142; if not, the data access unit 153 notifies the access request control unit 142 that the data has been improperly specified.

Also, the data access unit 153 writes, upon reception of a data write command (Write command) from the access request control unit 142, data into a specified location of the external storage apparatus 20. Then, the data access unit 153 notifies the access request control unit 142 about the write result. Here, when the slice being the write destination is a primary slice, a command for performing the similar writing is issued to the disk management unit which manages the corresponding secondary slice. Accordingly, the sameness of content is maintained between the primary slice and secondary slice.

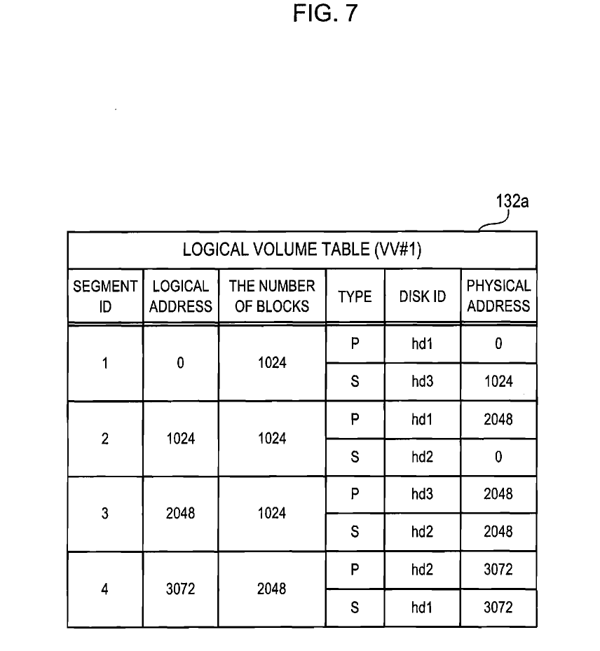

FIG. 7 is a view illustrating an exemplary data structure of logical volume table. The logical volume table 132a illustrated in FIG. 7 is a table illustrating a logical volume having a logical volume ID of “VV#1”. The logical volume table 132a is produced and managed by the logical volume management unit 132 of the control unit 130.

In the logical volume table 132a, there are provided items indicating segment ID, logical address, the number of blocks, type, disk ID and physical address. The pieces of information of each item laterally arranged are associated with each other.

In the item indicating segment ID, there is set a segment identification number. In the item indicating logical address, there is set the starting logical address of the segment. In the item indicating the number of blocks, there is set the number of blocks contained in the segment.

In the item indicating type, there is set one of “P” indicating primary slice and “S” indicating secondary slice. In the item indicating disk ID, there is set identification information on the external storage apparatuses 20, 30 and 40. Disk ID is automatically assigned by OS of the user terminal apparatus 100 at the time of initial connection. In the item indicating physical address, there is set a physical address indicating the starting block of slice.

The information stored in the logical volume table 132a is appropriately updated by the logical volume management unit 132. For example, a segment ID of “1”, a physical address of “0”, the number of blocks of “1024”, a type of “P”, a disk ID of “hd1” and a physical address of “0” are stored in the logical volume table 132a.

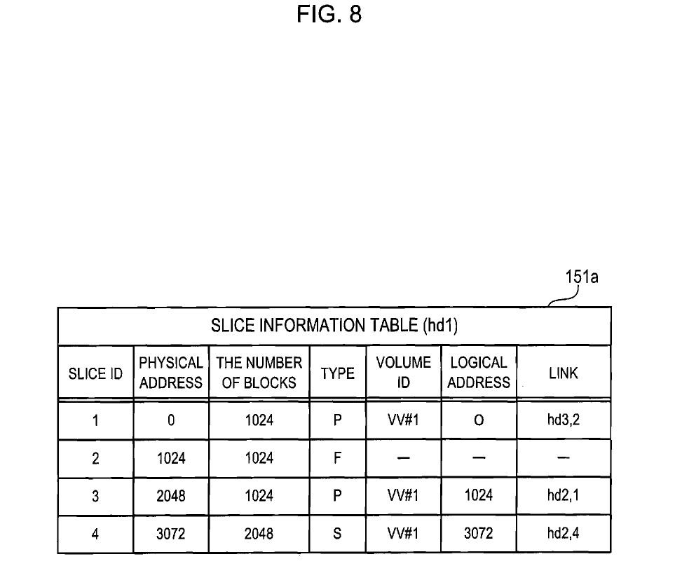

FIG. 8 is a view illustrating an exemplary data structure of slice information table. The slice information table 151a illustrated in FIG. 8 is a table indicating the slice of the external storage apparatus 20. The slice information table 151 a is stored in the slice information storage unit 151 of the disk management unit 150. The same table is also stored in the management information storage unit 131 of the control unit 130.

In the slice information table 151a, there are provided items indicating slice ID, physical address, the number of blocks, type, volume ID, logical address and link. The pieces of information of each item laterally arranged are associated with each other, constituting the slice information on the slice.

In the item indicating disk ID, there is set identification information of the external storage apparatuses 20, 30 and 40. In the item indicating physical address, there is set a physical address indicating the starting block of the slice. In the item indicating the number of blocks, there is set the number of blocks contained in the slice. In the item indicating type, there is set one of “P” indicating primary slice and “S” indicating secondary slice.

In the item indicating volume ID, there is set an ID of logical volume to which the segment associated with the slice belongs. In the item indicating logical address, there is set the starting logical address of the segment associated with the slice. In the item indicating link, there is set information on the other slice of the pair of slices, i.e., information on the secondary slice with respect to the primary slice or information on the primary slice with respect to the secondary slice. More specifically, there are set a disk ID and slice ID of the external storage apparatus for which a pair of slices exists.

For example, there are stored a slice ID of “1”, a physical address of “0”, the number of blocks of “1024”, a type of “P”, a volume ID of “VV#1”, a logical address of “0” and a link of “hd3, 2”. This indicates that the starting 1024 blocks of the data area of the external storage apparatus 20 constitutes one slice, and a segment from logical address block 0 to 1023 is assigned as the primary slice to the slice.

There will now be described in detail the processing for attaching/detaching the external storage apparatuses 20, 30 and 40 or the processing for dealing with a failure in the external storage apparatuses 20, 30 and 40; the processings are executed in the user terminal apparatus 100 having the above configuration and data structure.

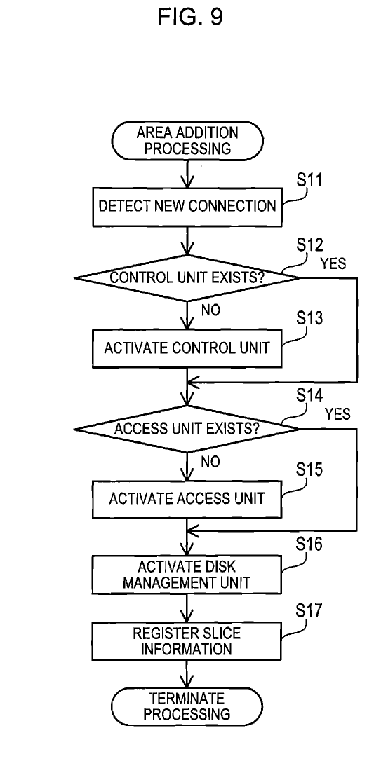

FIG. 9 is a flowchart illustrating a procedure of data area adding processing. The processing illustrated in FIG. 9 will be described below along the step numbers. Here, a case is assumed where the external storage apparatus 20 is connected to the user terminal apparatus 100.

[Step S11] The connection detection unit 110 detects that the external storage apparatus 20 has been connected to the external connection interface 106 of the user terminal apparatus 100. Then, the connection detection unit 110 notifies the program activation unit 120 that the external storage apparatus 20 has been detected.

[Step S12] The program activation unit 120 determines whether or not there currently exists the control unit 130 in the user terminal apparatus 100. If so, the operation proceeds to step S14; if not, the operation proceeds to step S13.

[Step S13] The program activation unit 120 accesses the program area 22 of the external storage apparatus 20 and reads a control program. Then, the program activation unit 120 activates the read control program in the user terminal apparatus 100 and thereby implements the control unit 130.

[Step S14] The program activation unit 120 determines whether or not there currently exists the access management unit 140 in the user terminal apparatus 100. If so, the operation proceeds to step S16; if not, the operation proceeds to step S15.

[Step S15] The program activation unit 120 accesses the program area 22 of the external storage apparatus 20 and reads an access management program. Then, the program activation unit 120 activates the read access management program in the user terminal apparatus 100 and thereby implements the access management unit 140.

[Step S16] The program activation unit 120 accesses the program area 22 of the external storage apparatus 20 and reads a disk management program. Then, the program activation unit 120 activates the read disk management program in the user terminal apparatus 100 and thereby implements the disk management unit 150.

[Step S17] The slice information management unit 152 of the disk management unit 150 accesses the data area 21 of the external storage apparatus 20 and checks the data storage state to produce slice information. Then, the slice information management unit 152 notifies the logical volume management unit 132 of the control unit 130 about the slice information on the external storage apparatus 20. The logical volume management unit 132 registers the slice information on the external storage apparatus 20 with the management information storage unit 131.

In this way, when the external storage apparatus 20 is connected to the user terminal apparatus 100, the connection detection unit 110 detects this. Subsequently, the program activation unit 120 checks the presence/absence of the control unit 130 and access management unit 140; if absent, the program activation unit 120 reads a program from the program area 22 of the external storage apparatus 20 and activates the program. Also, the program activation unit 120 activates the disk management unit 150 corresponding to the external storage apparatus 20. Then, after activated, the disk management unit 150 notifies the control unit 1 30 about the slice information, whereby the slice information is registered.

As a result, the data area 21 of the external storage apparatus 20 is automatically incorporated into the virtual disk area, so that the data area 21 can be used by the application programs executed in the user terminal apparatus 100. Further, when there is a huge difference of storage data quantity between the external storage apparatuses connected to the user terminal apparatus 100, data rearrangement is performed based on a command from the control unit 130, so that the load is distributed.

In the above description, the control program, access management program and disk management program are sequentially read from the program area 22 when needed; but they may be read all at once at the time of connection.

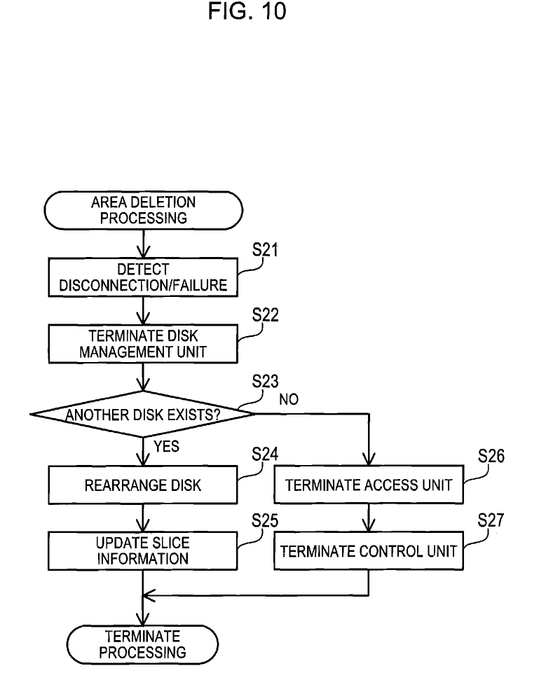

FIG. 10 is a flowchart illustrating a procedure of data area deleting processing. The processing illustrated in FIG. 10 will be described below along the step numbers. Here, a case is assumed where the external storage apparatus 20 has been disconnected from the user terminal apparatus 100 or the external storage apparatus 20 has failed.

[Step S21] The slice information management unit 152 of the disk management unit 150 detects that the external storage apparatus 20 is inaccessible. Here, this state where the external storage apparatus 20 is inaccessible includes: a case where the external storage apparatus 20 has been physically disconnected from the external connection interface 106 by a user operation; a case where the external storage apparatus 20 has been disconnected by means of software based on an OS setting; and/or a case where the external storage apparatus 20 has failed.

[Step S22] The slice information management unit 152 sends error notification to the logical volume management unit 132 of the control unit 130. Then, the slice information management unit 152 terminates the execution of the disk management unit 150 in the user terminal apparatus 100.

[Step S23] The logical volume management unit 132 determines, upon reception of the error notification from the slice information management unit 152, whether or not there exists another external storage apparatus connected to the user terminal apparatus 100. If so, the operation proceeds to step S24; if not, the operation proceeds to step S26.

[Step S24] The logical volume management unit 132 rearranges the data stored in the data area 21 of the external storage apparatus 20. More specifically, the logical volume management unit 132 accesses the slice information stored in the management information storage unit 131 and thereby identifies a slice which constitutes a pair with the slice of the external storage apparatus 20. Then, the logical volume management unit 132 causes another external storage apparatus to copy the specified slice, whereby data redundancy is restored.

[Step S25] The logical volume management unit 132 updates the slice information stored in the management information storage unit 131 to reflect the rearrangement result of step S24. Also, the logical volume management unit 132 deletes the slice information on the external storage apparatus 20 from the management information storage unit 131. Then, the logical volume management unit 132 reproduces a logical volume. Thereafter, the area deletion processing is terminated.

[Step S26] The logical volume management unit 132 notifies the access request control unit 142 of the access management unit 140 about the termination. The access request control unit 142 terminates, upon reception of the termination notification, the execution of the access management unit 140 in the user terminal apparatus 100.

[Step S27] The logical volume management unit 132 terminates the execution of the control unit 130 in the user terminal apparatus 100.

In this way, when the external storage apparatus 20 is disconnected or fails, the disk management unit 150 detects this. Then, the disk management unit 150 sends error notification to the control unit 130, and terminates itself. Upon reception of the error notification, the control unit 130 performs data rearrangement with another external storage apparatus when there exists another external storage apparatus, whereby data redundancy is restored; when there does not exist another external storage apparatus, the control unit 130 terminates the access management unit 140 and at the same time, terminates itself.

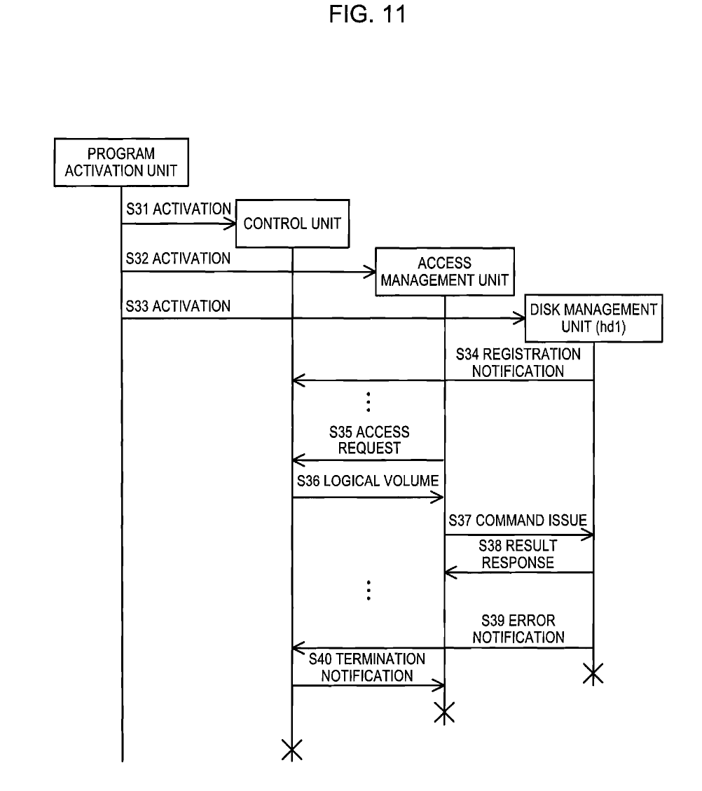

FIG. 11 is a sequence chart illustrating an exemplary flow from connection to disconnection. Here, a case is assumed where the external storage apparatus 20 is connected while all the external storage apparatuses 20, 30 and 40 have not been connected with the user terminal apparatus 100.

When the external storage apparatus 20 is connected to the user terminal apparatus 100, the program activation unit 120 firstly activates the control unit 130 (step S31). Subsequently, the program activation unit 120 activates the access management unit 140 (step S32). Then, the program activation unit 120 activates the disk management unit 150 which manages access to the external storage apparatus 20 (step S33). The activated disk management unit 150 notifies the control unit 130 about the slice information to cause the control unit 130 to perform registration (step S34). As a result, the data area 21 of the external storage apparatus 20 is incorporated into the virtual disk area.

Thereafter, when a data access request is made, the access management unit 140 sends a logical volume access request to the control unit 130 (step S35) and thereby acquires the latest logical volume (step S36). Then, the access management unit 140 identifies, based on the acquired logical volume, an external storage apparatus where the requested data has been stored. Here, if the requested data has been stored in the external storage apparatus 20, the access management unit 140 issues Read command or Write command to the disk management unit 150 (step S37) and acquires the resultant response to the command from the disk management unit 150 (step S38).

Thereafter, when the external storage apparatus 20 is disconnected from the user terminal apparatus 100, the disk management unit 150 sends error notification to the control unit 130 and then terminates itself. The control unit 130 sends, upon reception of the error notification, termination notification to the access management unit 140 to terminate the access management unit 140, and finally terminates itself.

With such user terminal apparatus 100, when the external storage apparatuses 20, 30 and 40 are connected, needed programs are read from the external storage apparatuses 20, 30 and 40 and automatically activated. Thereafter, application programs executed in the computer can use as a single virtual storage area, the data areas distributed on the multiple external storage apparatuses 20, 30 and 40. Consequently, there is no need to perform complex operations for software installation and setting; thus distributed storage environment can be constructed very easily.

Further, in the automatically constructed distributed storage environment, data is arranged in a distributed manner in the multiple external storage apparatuses 20, 30 and 40 and at the same time, each data is stored redundantly. Accordingly, there is provided the distributed storage environment with high response performance and reliability.

Also, when an idle external storage apparatus is connected, data rearrangement can be automatically performed so that the load is distributed. When part of the external storage apparatuses is disconnected or fails, data redundancy is automatically restored, whereby the operation can continue using the remaining external storage apparatuses. Accordingly, there is provided the distributed storage environment with high extensibility and flexibility.

The access management program, access management method and information processing apparatus according to the present invention have been described above with reference to the embodiment illustrated in the drawings. However, the present invention is not limited thereto, and the configuration of each units may be replaced with one having the similar function. Further, any other constituent component or step may be added to the present invention. Further, the present invention is also implemented by the combination of any two or more configurations (features) described in the above embodiment.

The above-described processing functions can be implemented by a computer, for example, user terminal apparatus 100. In this case, there is provided a program having described therein the processing content of functions to be provided in the user terminal apparatus 100. The processing functions can be implemented on the computer by executing the program on the computer. The program having described therein the processing content can be recorded on a recording medium readable by the computer. The recording medium readable by the computer includes a magnetic recording apparatus, optical disk, magnetooptic recording medium and semiconductor memory. The magnetic recording apparatus includes a hard disk apparatus (HDD), flexible disk (FD) and magnetic tape (MT). The optical disk includes DVD (Digital Versatile Disc), DVD-RAM, CD-ROM (Compact Disc-Read Only Memory), CD-R (Recordable)/RW (ReWritable). The magnetooptic recording medium includes MO (Magneto-Optical disk).

In order to distribute the program, portable recording media such as DVD and CD-ROM having recorded thereon the program are sold, for example. Also, the program may be stored in a recording apparatus of a server, so that the program is transferred from the server computer via a network to another computer.

The computer, which executes the program, stores in a recording apparatus thereof, the program recorded on the portable recording medium or the program transferred from the server computer. Then, the computer reads the program from the recording apparatus thereof and executes processings based on the program. Here, the computer may also read the program directly from the portable recording medium to execute the processing based on the program; or alternatively, each time the program is transferred from the server computer, the computer may execute processings based on the received program.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media, for example, a carrier-wave signal.

Further, according to an aspect of the embodiments of the invention, any combinations of the described features, functions, operations, and/or benefits can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A computer-readable storage medium storing a connection management program for causing a plurality of storage apparatuses connected to a computer to be accessible by the computer, the program causing the computer to perform operations comprising:
detecting, upon detecting that a new storage apparatus has been connected to the computer, whether the storage apparatus includes a data area capable of storing data and a program area having preliminarily stored therein a data access program for accessing the data area of the storage apparatus and a volume management program for managing a data storage destination in an integrated manner when storing data in a distributed manner in the plurality of storage apparatuses;
reading the data access program and the volume management program from the program area of the detected storage apparatus detected; and
activating the read programs in the computer.

2. The storage medium according to claim 1, wherein the activating comprises activating another data access program i for each detected storage apparatus ; and activating the volume management program only when the volume management program has not been previously activated in the computer.

3. The storage medium according to claim 2,
wherein the program area further stores an access request control program for identifying, upon reception of a data access request, a storage apparatus being the storage destination based on information managed by the volume management program and for calling the data access program corresponding to the identified storage apparatus; and
wherein the program activation unit reads the access request control program from the program area and activates the access request control program, when the access request control program has not been activated in the computer.

4. A connection management method for making a plurality of storage apparatuses connected to a computer to be accessible by the computer, the connection management method comprising:
detecting, upon detecting that a new storage apparatus has been connected to the computer, whether the storage apparatus includes a data area capable of storing data and a program area having preliminarily stored therein a data access program for accessing the data area of the storage apparatus and a volume management program for managing a data storage destination in an integrated manner when storing data in a distributed manner in the plurality of storage apparatuses;
reading the data access program and the volume management program from the program area of the detected storage apparatus; and
activating the programs in the computer.

5. The connection management method according to claim 4, wherein the activating comprises activating another data access program for each detected storage apparatus; and activating the volume management program only when the volume management program has not been previously activated in the computer.

6. The connection management method according to claim 5,
wherein the program area further stores an access request control program for identifying, upon reception of a data access request, a storage apparatus being the storage destination based on information managed by the volume management program and for calling the data access program corresponding to the identified storage apparatus; and
wherein the program activation unit reads the access request control program from the program area to activate the access request control program, when the access request control program has not been activated in the computer when activating the data access program.

7. An information processing apparatus accessing a plurality of storage apparatuses, the apparatus comprising:
a computer controller
detecting, upon detecting that a new storage apparatus has been connected, whether the storage apparatus includes a data area capable of storing data and a program area having preliminarily stored therein a data access program for accessing the data area of the storage apparatus and a volume management program for managing a data storage destination in an integrated manner when storing data in a distributed manner in the plurality of storage apparatuses, and
reading the data access program and the volume management program from the program area of the detected storage apparatus detected; and
activating the programs.

8. The information processing apparatus according to claim 7, wherein the activating comprises activating another data access program for each detected storage apparatus; and activating the volume management program only when the volume management program has not been previously activated in the computer.

9. The information processing apparatus according to claim 8,
wherein the program area further has stored therein an access request control program for identifying, upon reception of a data access request, a storage apparatus being the storage destination based on information managed by the volume management program and for calling the data access program corresponding to the identified storage apparatus; and
wherein the activating reads the access request control program from the program area and activates the access request control program, when the access request control program has not been activated in the computer.

10. The apparatus according to claim 8, wherein the operations of the computer further comprise:
detecting disconnection and/or failure of a storage apparatus;
terminating a data access program corresponding to the disconnected and/or failed storage apparatus;
rearranging data of the disconnected and/or failed storage apparatus, based upon other storage apparatus storing the data; and
updating another data access program corresponding to the other storage apparatus.
